(19) United States
(12) Patent Application Publication
(10) Pub. No.: US 2003/0213860 A1
(43) Pub. Date: Nov. 20, 2003

(54) Taper refiner for the defibering of wood chips and similar materials

(76) Inventor: Milton Pilao, Sao Paulo (BR)

Correspondence Address: Ladas & Parry, 26 West 61 Street, New York, NY, 10023, US

(21) Appl. No.: 10/304,466

(22) Filed: Nov. 26, 2002

(30) Foreign Application Priority Data
May 17, 2002 (BR) PI0202031-9

(51) Int. Cl. B02C 7/00

(52) U.S. Cl. 241/261.1

(57) ABSTRACT

“IMPROVEMENTS IN TAPER REFINER FOR THE DEFIBERING OF WOOD CHIPS AND SIMILAR MATERIALS”, comprising the superposition of a taper rotor (18) and an equally tapered stator (19), with refining faces directly facing each other, thereby, defining a refining zone which receives the material to be defibered, properly impregnated with vapor, from where this material leaves defibered and free of both vapors, that is, the vapor first introduced with the wood chips and the vapor generated during the defibering operation, with said rotor (18) consisting of a hub (20) as the means for attaching it to the motor drive shaft (16), interconnected by radial fins (21) to a hollow frustum housing (22-23), and also provided, at the smaller diameter end, with a front cover (24) featuring vapor passage holes (25) positioned between chip breaking blades (26), additionally, said rotor delimitates an internal sub-chamber (14) that accommodates a turbine formed by suction blades (15) rotating together with the rotor (18), for the suction of the vapor introduced and generated inside the refining chamber, with a separate side outlet (13) for the return and reclamation in equipment's continuous cooker.

As we all already know and particularly the technicians familiar with the industry of equipment for the refinement of high consistency pulp, such as the defibering of wood chips and similar materials, the generation of vapor, during the refining cycle, which is caused by the friction of the material in the refining areas, leads to various inconveniences, such as the high energy consumption, early blade wear, and the need of a sophisticated vapor recovery system.

It is clear that the solution of the problem above, particularly with regard to a substantial reduction of power consumption, is to diminish the rotation of the material during the defibering in the refining zone, what could be achieved by removing the vapor from the said refining chamber, both the one introduced together with the material do be defibered and that generated during the defibering operation, thereby, obtaining an uniform material flow inside de equipment.

Furthermore, the said and desired removal of vapor will provide a significant increase in the retention of the volume of the material in the refining zone, which would, consequently, improve the system control and relieve the defibering areas.

Finally, by having an uniform material flow and by removing the vapor resulting from a low refining intensity, an uniform quality of freenes may be obtained. All points indicated above as well as others related to them, may be achieved by the improved taper refiner which constitutes the purpose of the present invention. This improved taper refiner has been specially designed for applications that require high power consumption in the refining of high consistency pulp, such as the defibering of wood chips and similar materials. It considerably reduces the power consumption while keeping the unit's production capacity.

This new high yield paste refining technology used by the improved taper refiner presented herein provides an efficient system for the evacuation of both the vapor generated during chip friction in the refining areas and the vapor that goes into the refiner from the continuous cooker used for cooking the chips.

Furthermore, the removal of this large volume of vapor is carried out without causing any trouble to the feed of the material to the refining areas. The result is a constant feed, without the fiber mixing with the vapor during defibering.

On the other side, with regard to the unit discharge, a simultaneous and uniform separation is performed therein, through independent outlets, one for the vapor and the other for the defibered material.

In short, the improved taper refiner for the defibering of wood chips and similar materials essentially consists of the superimposition of a mobile taper rotor over a stationary taper rotor, with refining faces set towards each other, defining an intermediate refining zone, whereas the material to be defibered enters the refining zone properly impregnated with vapor and comes out from said zone fully free of vapor, regardless of such a vapor being introduced or generated during defibering.

The drawings attached herein illustrate the present invention, and include the following:

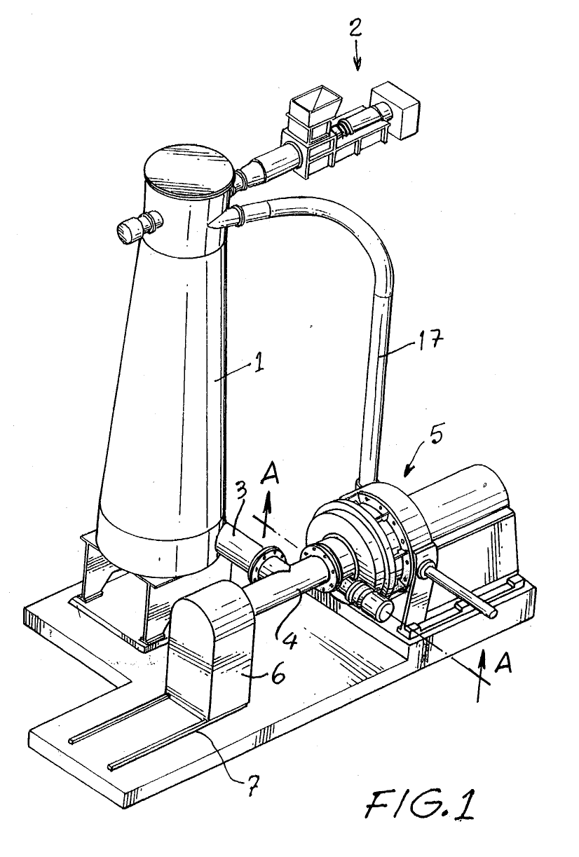

FIG. 1—Schematically shows a plant for the defibering of wood chips equipped with the improved taper refiner presented herein;

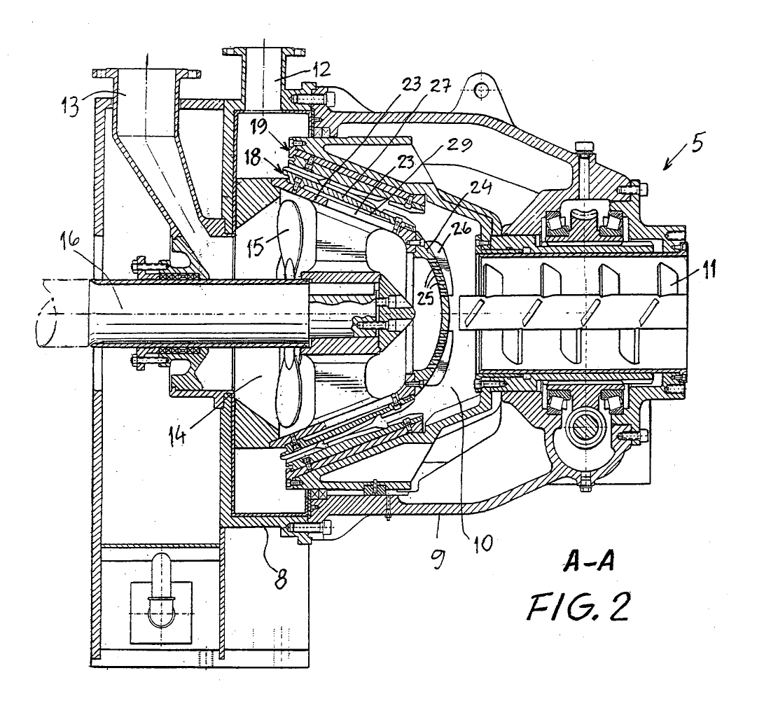

FIG. 2—A longitudinal section of the improved taper refiner, as per A-A of FIG. 1;

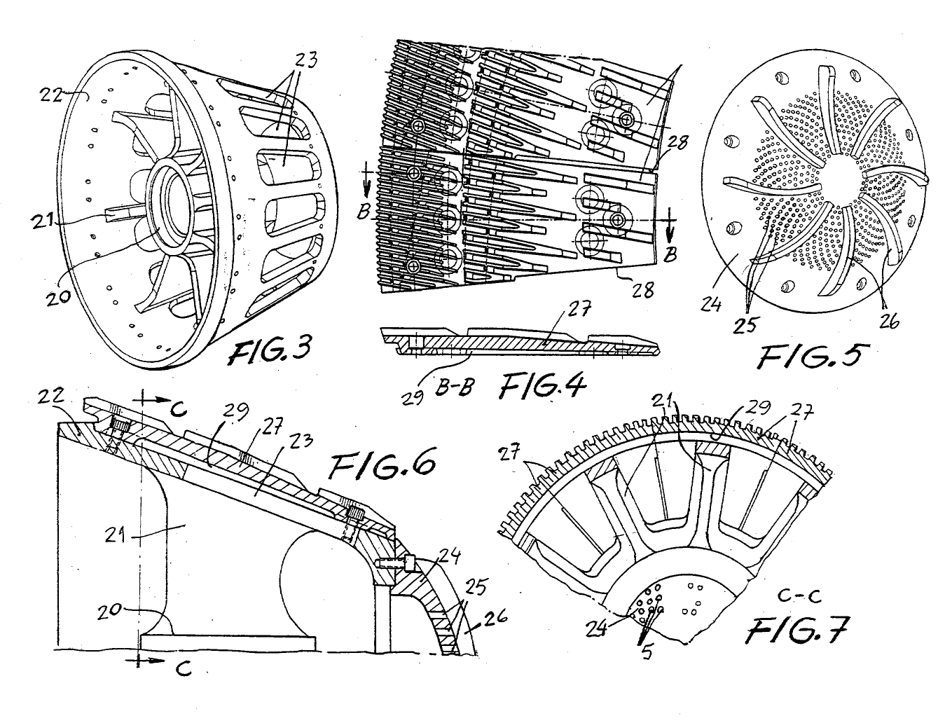

FIG. 3—Illustrates, in perspective view, the component formed by the unit's taper rotor hub and housing; (4/11)

FIG. 4—Shows by means of a side view and cross section B-B, as indicated in the side view, a pair of refining blades to be applied to the taper rotor housing illustrated in FIG. 3;

FIG. 5—It is a perspective view of a front cover for the referred to taper rotor;

FIG. 6—It is a longitudinal section of the taper rotor, already with the refining blades and front cover in place;

FIG. 7—It is a cross section, as per C-C, indicated in FIG. 6;

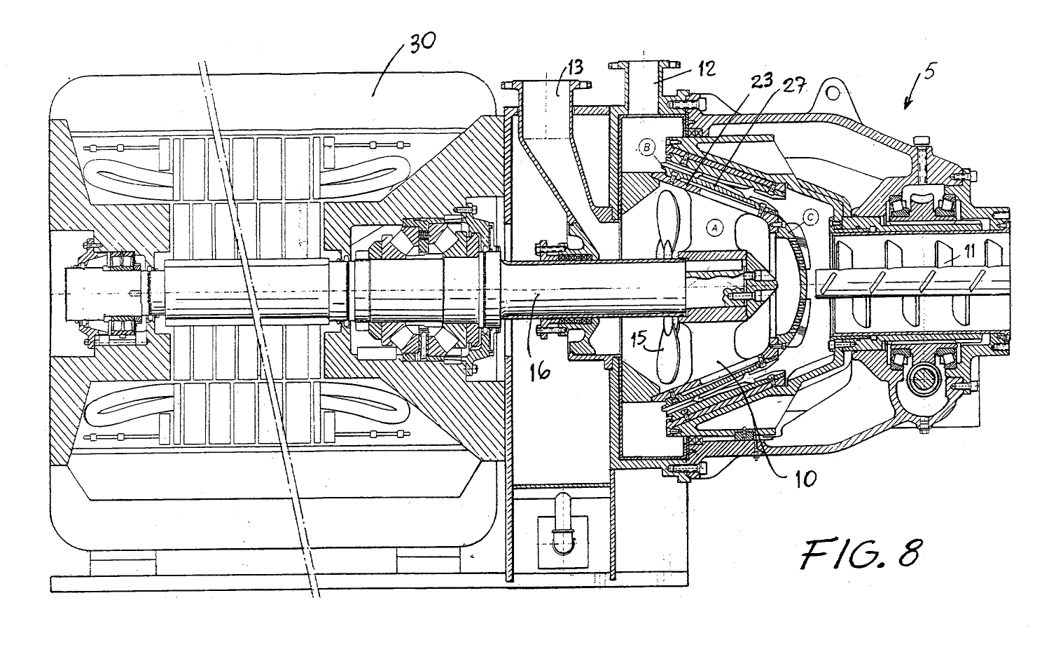

FIG. 8—It is a longitudinal cross section of the improved taper refiner presented herein, in a compact unit, with an integrate rotor/ and

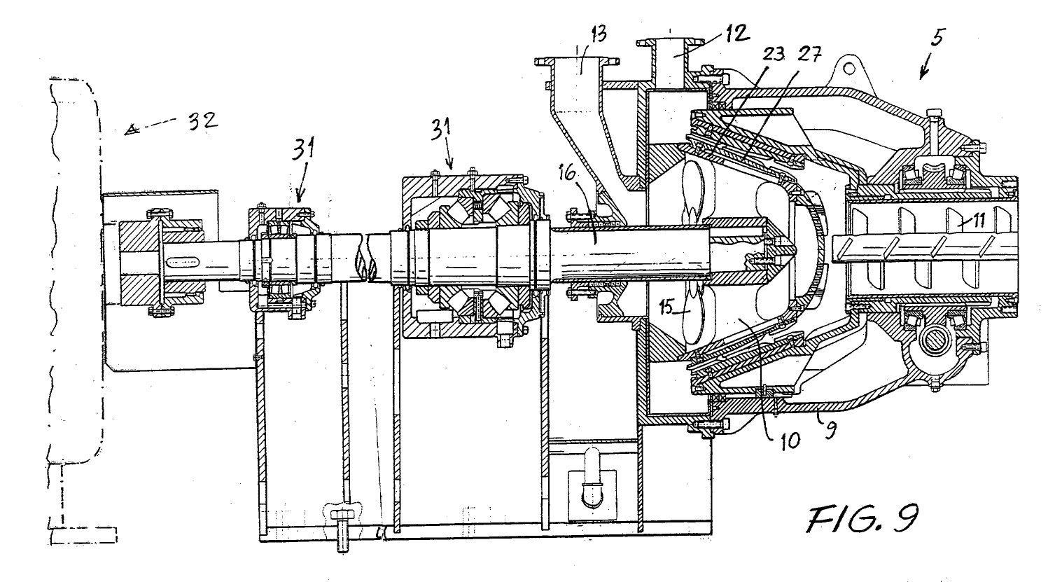

FIG. 9—Repeats the longitudinal section of the improved taper refiner supported by bearings and firmly coupled to a separate motor.

According to the illustration of the figures listed above, and particularly FIG. 1, the illustrations show a possible and preferred installation for the defibering of wood chips and similar materials, essentially including a vapor impregnator or continuous cooker 1 for the wood chips which receives the load of material from the side and upper portion of a chip feeder 2, and with a side and lower portion outlet 3 for the material already impregnated to a tubular conductor 4 which feeds the improved taper defibering machine or refiner 5 of the present invention, including a coupled or separate motor, said tubular conductor 4 internally housing a spiral conveyer feeder, and being afterward applied to a mobile support 6, moveable over rails 7, for its movement with relation to the taper defibering machine 5, providing the possibility of changing the tapers for maintenance or similar operations.

Now, with regard to the improved taper refiner or defibering machine 5, the subject matter of the present invention (FIG. 2), it initially consists of a housing or case 8, with a pivoted cover 9, and forms a large internal chamber 10, for accommodating the refiner or defibering machine assembly itself, a chamber that is provided with a front opening through which passes the tubular conductor 4 that feeds the wood chips to be defibered, with an internal spiral conveyer 11.

Additionally, the referred to internal chamber 10 of the improved refiner or defibering machine presented herein is provided with two separate tubular side openings as outlets, of which one 12 directly deriving from the refining zone, and serving as the outlet for the defibered material, and the other 13 serving as the outlet for the vapor coming from a sub-chamber 14, formed internally to the refiner assembly rotor, where a turbine formed by suction blades 15 is provided, mounted in the same drive shaft 16 as the rotor's, with an integrate or separate motor, and the referred to side vapor outlet 13 receiving externally a vapor conductor piping 17 returning to the continuous cooker 1 of the chip defibering plant (FIG. 1).

As to the refiner or defibering machine assembly itself, it accommodates a taper rotor 18 assembled at the end of the corresponding drive shaft 16, and an equally tapered stator 19 fixedly attached inside the chamber 10, both with refining faces directly facing each other, defining an intermediate refining zone which receives the material to be defibered, properly impregnated with vapor, and from where it comes out, through the separate side outlet 12, already defibered and fully free of the vapor that had been either introduced or generated during defibering.

For that much, the improvements under consideration herein introduce a special construction composition for the taper rotor of the refiner or defibering machine assembly itself (FIGS. 3 and 5), where this rotor consists of a central hub 10 to be fixed at the end of the drive shaft 16 of the drive motor, and it is interconnected by radial fins 21 to a frustum housing 22, serving as the base for the refining blades, and said housing featuring an intermediate circumferential alignment with large openings or side windows 23 (FIG. 3), so as to allow the vapor to pass through, and still receiving, at the smaller diameter end, a front cover 24 (FIG. 5), centered with relation to the front inlet of material to be defibered (FIG. 2), and having its surface fully provided with small vapor pass-through holes 25, positioned between the chip breaking blades 26.

Furthermore, with reference to the taper rotor 18 of the improved refiner or defibering machine assembly under consideration herein, the refining blades 27 which are applied and conveniently attached externally to its frustum housing has at least one of its longitudinal side edges provided with a long and narrow slot 28, delimiting, by means of the lateral superimposition of another equal refining blade (FIG. 4), a thin vapor passage slit which communicates with the longitudinal setback formed in the internal face of each blade 27, establishing, thereby, a wide communication with the large windows or side openings 23 of that frustum housing 22 towards the sub-chamber 14 formed internally and at the rear of the taper rotor.

In the improved refiner or defibering machine described above, all material to be defibered, and properly impregnated with vapor in the impregnator or continuous cooker 1 is forwarded by the feed tubular conductor 4, and internal spiral conveyer 11, to the front inlet at the pivoted cover 9 of the refiner or defibering machine assembly, already positioned towards the front cover 24 of the taper rotor 18 with its vapor pass-through holes 25 and breaking blades 26.

Inside the internal chamber of the refiner or defibering machine 5, said material still impregnated with vapor is diverted to the refining zone delimited between the face-to-face refining faces of the taper rotor 18 and equally tapered stator 19 for the actual defibering operation, as expected with simultaneous generation of vapor.

The main characteristic of the improved assembly under consideration herein is based on the fact that during the defibering operation, all vapor present inside the unit, that is, the vapor introduced together with the wood chips and the vapor generated during defibering, is sucked by the turbine blades 15 of the drive shaft 16, and through the holes 25 on the front cover of the rotor 18, as well as through the side slots 28 and internal longitudinal setbacks 29 of the refining blades 27, and mainly through the large side openings or windows 23 of the rotor housing 22, routing afterwards to sub-chamber 14 that is formed internally and at the rear of the rotor, from there, going out through the separate lateral opening 13 and manifold 17, and, then, returning to the reclamation in the unit's cooker 1.

Once the entire vapor is so diverted to the separate and side outlet 13, towards its reclamation, the defibered and fully free of vapor material is sent from the refining zone to the actual side outlet 12 which is a separate outlet as well.

It is worth mentioning that the improved refiner or defibering machine, as described above, may also be normally used with an integrate motor 30 (FIG. 8), or conveniently supported by bearings 31 and coupled to a separate motor 32 (FIG. 9).

In addition to the characteristics above, there are others of equal importance in the assembly, namely:

Pressurized set for continuous operation which may be applied to digesters or continues cookers;

Reinforced construction on a simple base;

Compact unit providing considerable space saving, specifically with the integrate motor;

Electromechanical taper adjustment;

Easy access for taper replacement or maintenance;

Integrate motor or rolling bearings, with continuous lubrication;

All parts preferably made of stainless steel;

Optional automatic controls;

Selectable front feed and pulp outlet on the sides;

Vapor outlet by the center of the mass chamber.

Emphasis should also be given to the fact that the improved assembly, as the invention under consideration herein, was designed for fewer restrictions and a wide range of applications.

Moreover, the improved assembly described herein features an accurate electromechanical positioning system, with regard to the stator or rotor inside the unit, thereby, permitting a versatile adjustment with variable speed as well as the possibility of local control, whether manually or through a control panel.

On the other side, it also permits an easy access for taper replacement, by means of simply moving aside the feed tubular conductor, thereby, enabling the opening of the refining door, for a simple and quick inspection and/or taper replacement.

If the assembly has a fixed shaft coupled to the motor, this will extend the durability of the bearings, and provide a more stable refining operation.

If the assembly has the motor directly coupled to the rotor, the entire shaft rotation system may be eliminated, including rolling bearings and coupling, enabling the motive power to be applied directly to the defibering, in addition to maximizing the power applied with stability.

In addition to all these features it is worth mentioning that the improved assembly features a large taper refining area, offering a low refining intensity and high production.

Finally, it is also worth mentioning some benefits that pulp manufactures will have with the technology offered by the improved refiner or defibering machine under the invention presented herein, namely:

Return of the vapor directly from the refining chamber to the continuous cooker;

Deactivation of the vapor recovery system currently used;

Use of the spiral conveyer which provides the refiner with an efficient and uniform feed of the material to the defibering zone;

Substantial power consumption reduction, with the maximum refiner output;

Low refining intensity due to the uniform flow achieved by having the vapor evacuated from the inside of the defibering chamber;

Efficient vapor suction system performed through the turbine installed in the rotor's internal chamber;

Tube for the removal of the vapor from the inside of the refiner put at the turbine outlet, with easy routing of the vapor towards the continuous cooker.

1- “IMPROVEMENTS IN TAPER REFINER FOR THE DEFIBERING OF WOOD CHIPS AND SIMILAR MATERIALS”, of the type that essentially accommodates the superposition of a taper rotor (18), mounted at the end of a corresponding drive shaft (16) and an equally tapered stator (19) fixedly mounted inside the refining chamber (10) both with the refining faces directly facing each other, defining an intermediate refining zone that receives the material to be defibered, properly impregnated with vapor, characterized by the fact that the rotor (18) consists of a central hub (20) fixable at the drive motor shaft end (16), and interconnected by means of radial fins (21) to a frustum housing (22) serving as the base for the refining blades, and said housing (22) provided with an intermediate circumferential alignment with large openings or side windows (23) so as to allow the vapor to pass through, and also, receiving in the smaller diameter end a front cover (24), centered with relation to the front inlet of material to be defibered, and having its surface fully provided with small vapor pass-through holes (25), positioned between the chip breaking blades (26).

2- “IMPROVEMENTS IN TAPER REFINER FOR THE DEFIBERING OF WOOD CHIPS AND SIMILAR MATERIALS”, as claimed in 1, characterized by the fact that, still with regard to the taper rotor (18), the refining blades (27) which are applied and conveniently fixed externally to the referred to frustum housing (22), has at least one of its longitudinal side edges provided with a long and narrow slot (28), delimiting, by means of the lateral superimposition of another equal refining blade, an intermediate thin vapor passage slit which communicates with the longitudinal setback (29) formed in the internal face of each blade (27), establishing, thereby, a wide communication with the large windows or side openings (23) of that frustum housing (22) toward the sub-chamber (14) formed internally and at the rear of the taper rotor (18).

3- “IMPROVEMENTS IN TAPER REFINER FOR THE DEFIBERING OF WOOD CHIPS AND SIMILAR MATERIALS”, as claimed in 1 or 2, characterized by the fact that the housing or case (8) with a pivoted cover (9) which forms the refiner or defibering machine housing, are provided with a front opening through which passes the tubular conductor (4), including the internal spiral conveyer (11) whose function is to feed wood chips to be defibered, inside the refining chamber (10), whereas said chamber (10 is provided with two separate tubular side openings as outlets, of which one (12) directly deriving from the refining zone, and serving as the outlet for the defibered material, and the other (13) serving as the outlet for the vapor coming from the referred to sub-chamber (14), formed internally to the refiner assembly rotor (18), where a turbine formed by suction blades (15) is provided, mounted in the same drive shaft (16) as the rotor's, with an integrate or separate motor, and the referred to side vapor outlet (13) receiving externally a vapor conductor piping (17) returning to the continuous cooker 1 of the chip defibering plant.
